(19) United States
(12) Patent Application Publication
(10) Pub. No.: US 2026/0001317 A1
(43) Pub. Date: Jan. 1, 2026

(54) INKJET PRINTHEAD WITH POWER AND DATA SUPPLIED BETWEEN ROWS OF PRINT CHIPS

(71) Applicant: MEMJET TECHNOLOGY LIMITED, Dublin 2 (IE)

(72) Inventors: Jason Thelander, North Ryde (AU); Norman Berry, North Ryde (AU); David Burke, North Ryde (AU); Mark Profaca, North Ryde (AU); Robert Smeallie, North Ryde (AU)

(21) Appl. No.: 19/240,906

(22) Filed: Jun. 17, 2025

Related U.S. Application Data
(60) Provisional application No. 63/666,377, filed on Jul. 1, 2024.
(60) Provisional application No. 63/668,497, filed on Jul. 8, 2024.

(51) Int. Cl. B41J 2/045; B41J 2/14; B41J 2/175

(52) U.S. Cl. CPC B41J 2/04548; B41J 2/14; B41J 2/17523; B41J 2/04586; B41J 2002/14419; B41J 2002/14491; B41J 2202/18; B41J 2202/20

(57) ABSTRACT

An inkjet printhead includes: an elongate manifold having through-holes defined through a thickness of the manifold and ink supply channels extending along a length of the manifold. First and second rows of butting print chips are mounted to a lower face of the manifold and receive ink from the ink supply channels. A first PCB is mounted to lower face of the manifold between the first and second rows of print chips. The first PCB receives power and data via the through-holes from a second PCB and the first PCB distributes the power and data to both the first and second rows of butting print chips at either side thereof.

### CROSS-REFERENCE TO RELATED APPLICATIONS

This application claims the benefit of priority to co-owned and co-pending U.S. Provisional Patent Application Ser. No. 63/666,377 filed Jul. 1, 2024, and entitled “LOW-COST INKJET PRINTHEAD FOR REDUNDANT PRINTING”, as well as co-owned and co-pending U.S. Provisional Patent Application Ser. No. 63/668,497 filed Jul. 8, 2024, and entitled “INTERLEAVABLE LOW-COST INKJET PRINTHEAD”, the contents of each of the foregoing being incorporated herein by reference in their entireties.

### TECHNOLOGICAL FIELD

This present disclosure relates to an inkjet printhead. It has been developed primarily to provide a robust, full-color printhead suitable for high quality pagewide printing in a modular array of stitched printheads.

### BACKGROUND

The Applicant has developed a range of Memjet® inkjet printers as described in, for example, WO2011/143700, WO2011/143699 and WO2009/089567, the contents of which are incorporated herein by reference in their entireties. Memjet® printers employ one or more stationary inkjet printheads in combination with a feed mechanism which feeds print media past the printhead in a single pass. Memjet® printers therefore provide much higher printing speeds than conventional scanning inkjet printers.

Digital presses suitable for relatively short print runs represent a significant market opportunity for pagewide printing technology. Pagewide inkjet printing units may be used to replace traditional analogue printing plates in an offset press without significant modifications to expensive media feed systems. The present Applicant has developed printing systems suited to the needs of OEMs wishing to upgrade existing offset presses to high-speed digital inkjet presses. For example, U.S. Pat. No. 10,099,494 (the contents of which being incorporated herein by reference in its entirety) describes a modular printing system comprising monochrome print bars having one or more print modules. Each print module has 5× redundancy by virtue of 5 nozzle rows in a respective printhead, providing high quality, high speed printing suited to the requirements of inkjet press OEMs. The modular printing system may be configured for full color printing by stacking monochrome print bars along a media feed path, as described in U.S. Pat. No. 10,099,494.

Notwithstanding these improvements in modular inkjet printing systems, there is still a need to improve such systems further. One disadvantage of using an array of monochrome print bars is that the overall span of the print zone along the media feed direction is relatively long. Even with innovative measures to minimize inter-print bar separation, the print zone for four print bars (e.g. CMYK print bars) may still be up to 500 mm or up to 1000 mm in length along the media feed path. Longer print zones create challenges, not only in terms of alignment and accurate dot-on-dot placement, but also integration into an existing offset media feed system. For example, limited space may be available for an inkjet print engine in the media feed path and reconfiguring media feed systems to accommodate such a print engine is costly for OEMs.

One approach to minimizing the size of the print zone is to print four colors of ink from the same printhead. For example, U.S. Pat. No. 10,293,609 describes a full-color printhead having two rows of print chips with each row printing two colors of ink with 2× redundancy. The two rows of print chips are mounted on an Invar ink manifold, which provides a high degree of stiffness compared to polymer manifolds (e.g. LCP manifolds). The rigidity of the ink manifold enables long printheads to be manufactured (sec, for example, Memjet DuraFlex® and DuraBolt™ print systems having A3-sized Invar printheads). However, Invar ink manifolds necessarily add to the overall cost of such printheads. Furthermore, they are less suited to high-volume manufacturing than printheads having molded polymer ink manifolds.

It would therefore be desirable to provide a cost-effective full-color printhead with redundancy in each color. It would be further desirable to provide a versatile printhead that is suitable for stitching with similar printheads in a modular pagewide arrangement. Efficient arrangements for supplying ink, power and data to rows of print chips in the printhead would also be desirable.

### SUMMARY

In one aspect, an inkjet printhead is disclosed. In one embodiment, the inkjet printhead includes an elongate manifold having: an upper face and a lower face: one or more through-holes defined through a thickness of the manifold, said through-holes being positioned towards a central longitudinal axis of the manifold, and ink supply channels extending along a length of the manifold, the ink supply channels being positioned towards first and second opposite sides of the manifold relative to the through-holes; first and second rows of butting print chips mounted to the lower face of the manifold, the first row of butting print chips extending along the first side of the manifold and the second row of butting print chips extending along the opposite second side of the manifold, each print chip in the first row receiving ink from at least one ink supply channel at the first side of the manifold and each print chip in the second row receiving ink from at least one ink supply channel at the second side of the manifold; a first PCB mounted to the lower face of the manifold between the first and second rows of print chips, wherein: the first PCB receives power and data via the through-holes from a second PCB; and the first PCB distributes the power and data to both the first and second rows of print butting chips at either side thereof.

In another embodiment, the inkjet printhead includes an elongate manifold having: an upper face and a lower face: ink supply channels extending along a length of the manifold; first and second rows of butting print chips mounted to the lower face of the manifold, the first row of butting print chips extending along the first side of the manifold and the second row of butting print chips extending along the opposite second side of the manifold, each print chip in the first row receiving ink from at least one ink supply channel at the first side of the manifold and each print chip in the second row receiving ink from at least one ink supply channel at the second side of the manifold; and a stiffener plate fastened to the upper face of the manifold, wherein: the manifold is comprised of a moldable first material; and the stiffener plate has a higher degree of stiffness than the manifold, the stiffener plate being comprised of a second material different than the first material.

In another aspect, a print bar that includes a modular array of the aforementioned printheads is disclosed.

As used herein, the term “ink” is taken to mean any printing fluid, which may be printed from an inkjet printhead. The ink may or may not contain a colorant. Accordingly, the term “ink” may include conventional dye-based and pigment-based inks, infrared inks, UV inks, fixatives (e.g. pre-coats and finishers), functional fluids (e.g. solar inks, sensing inks), 3D printing fluids, biological fluids and the like. Where reference is made to fluids or printing fluids, this is not intended to limit the meaning of “ink” herein.

As used herein, the term “mounted” includes both direct mounting and indirect mounting via an intervening part.

### BRIEF DESCRIPTION OF DRAWINGS

Embodiments of the present disclosure will now be described by way of example only with reference to the accompanying drawings, in which:

FIG. 1 is a top perspective of a printhead according to a first embodiment;

FIG. 2 is a bottom perspective of a printhead shown in FIG. 1;

FIG. 3 is a top perspective of the printhead shown in FIG. 1 with an upper second PCB removed;

FIG. 4 is a top perspective of the printhead shown in FIG. 1 with an upper second PCB and membrane gasket removed;

FIG. 5 is a sectional perspective of a manifold for the printhead according to the first embodiment;

FIG. 6 shows a first PCB meeting with a second row of print chips with one print chip removed to reveal ink outlets in the manifold;

FIG. 7 is a magnified bottom perspective of one end of the printhead according to the first embodiment;

FIG. 8 is a bottom perspective of a print bar comprising printheads according to the first embodiment;

FIG. 9 is a top perspective of the print bar shown in FIG. 8;

FIG. 10 is a top perspective of a printhead according to a second embodiment;

FIG. 11 is a bottom perspective of a printhead shown in FIG. 10;

FIG. 12 is a top perspective of the printhead shown in FIG. 10 with an upper second PCB and mounting block removed;

FIG. 13 is a top perspective of the printhead shown in FIG. 12 with a cover plate removed;

FIG. 14 a top perspective of a manifold for the printhead according to the second embodiment;

FIG. 15 is a sectional perspective of the manifold shown in FIG. 14; and

FIG. 16 is a bottom perspective of a print bar comprising printheads according to the second embodiment.

### DETAILED DESCRIPTION

### First Embodiment

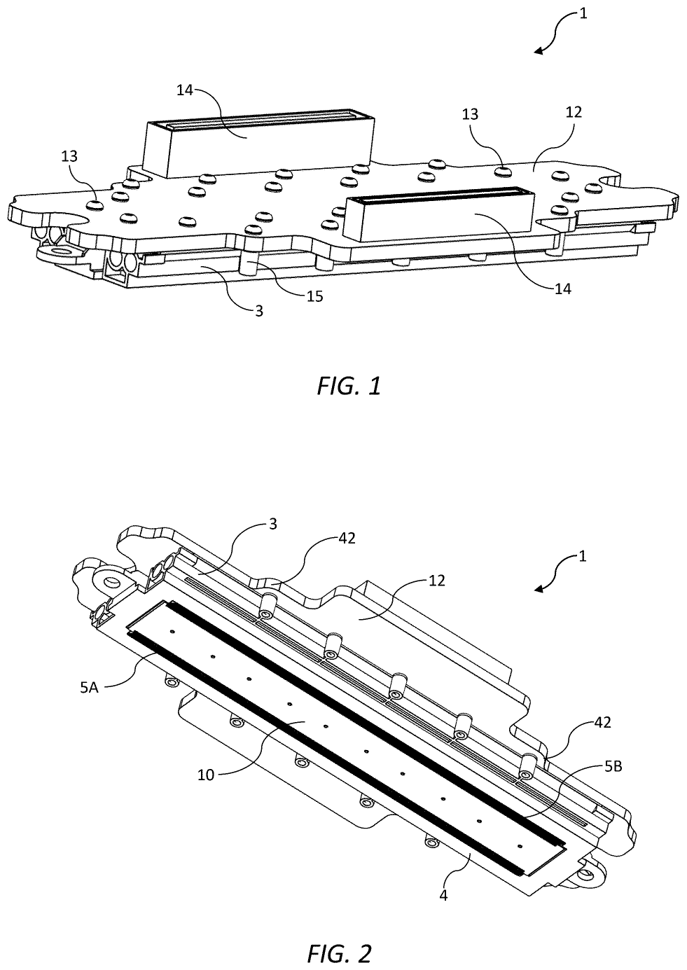

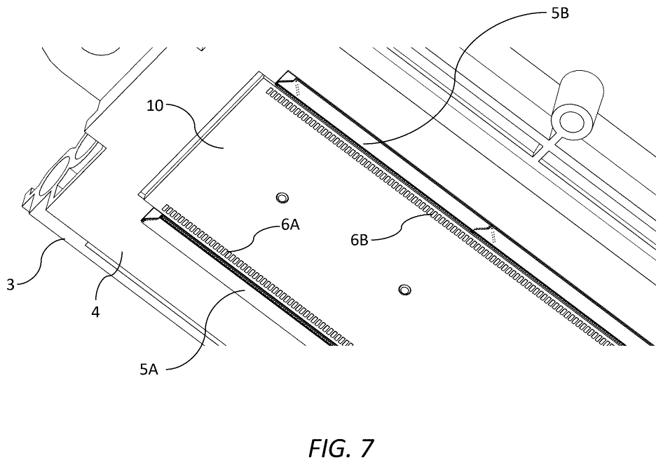

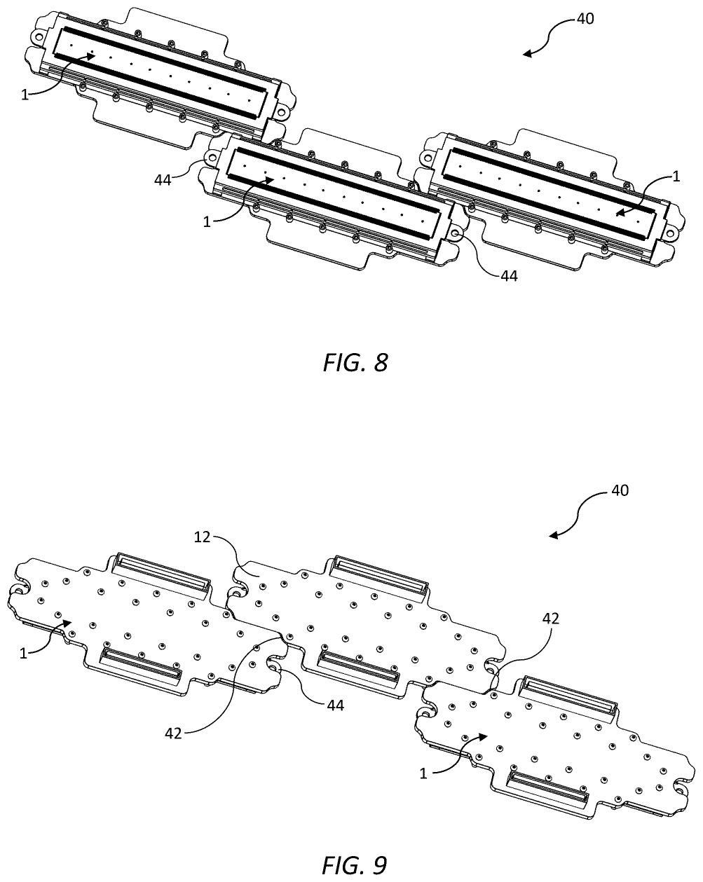

Referring to FIGS. 1 to 7, there is shown a first inkjet printhead 1 (or “print module” when used in a modular array of the type shown in FIGS. 8 and 9) according to a first embodiment. The first printhead 1 comprises an elongate manifold 3 configured for supplying ink and power/data to a first row of print chips 5A and a second row of print chips 5B mounted to a lower face 4 thereof. A first PCB 10 is also mounted to the lower face 4 of the manifold 3 between the first and second rows of print chips 5A and 5B. The first PCB 10 extends generally co-extensively with the rows of print chips 5 along a length of the first printhead 1 and distributes power and data to both the first row 5A and the second row 5B of print chips via respective first and second rows of contact pads 6A and 6B disposed along each of its opposite lateral edges. Referring to FIGS. 6 and 7, the contact pads 6 are electrically connected to bond pads 8 extending along longitudinal edges of the print chips 5 via suitable wirebonds (not shown). Accordingly, the first and second rows of print chips 5A and 5B are oppositely oriented relative to each other, which enables their respective bonds pads 8 to be positioned proximal the first PCB 10 for connection thereto.

Each of the first and second rows of print chips 5A and 5B contains six individual print chips butted end-on-end for a total of twelve print chips in the first printhead 1. Print chips configured for butting end-on-end in a pagewide arrangement will be known to the person skilled in the art. For example, the Applicant's dropped nozzle triangle architecture for linking print chips in a row is described in U.S. Pat. No. 7,290,852, the contents of which are incorporated herein by reference in its entirety.

Typically, the manifold 3 takes the form of an LCP molding, which may be manufactured in high volumes and at relatively low cost. A stiffener plate, in the form of a second PCB 12 in this first embodiment, is attached to an upper face 9 of the manifold 3 (via screw fasteners 13 received in screw bosses 15) and extends parallel with the first PCB 10 mounted to the lower face 4. The second PCB 12 communicates power and data signals to the first PCB 10, as well as providing a rigid backbone for the first printhead 1. As shown in FIG. 1, the rigid second PCB 12 may have a larger arca than the manifold 3 (in plan view) to provide suitable abutment features 42 for aligning printheads in a staggered overlapping array (see FIG. 9). Power and data ports 14 extend from an upper surface of the second PCB 12 for connection to an external print controller and/or power source (not shown)

The first PCB 10 receives power and data from the second PCB 12 via through-holes 16 defined through a thickness of the manifold 3. The through-holes 16 (in the form of five separate slots in this first embodiment) are positioned along a central longitudinal axis of the manifold 3. Each through-hole 16 receives a plurality of electrical connector pins 18, which interconnect the first PCB 10 with the second PCB 12. Upper and lower insulator blocks 20 group the connector pins 18 into discrete connector units 22, which can be readily assembled and placed in respective through-holes 16 during manufacturing.

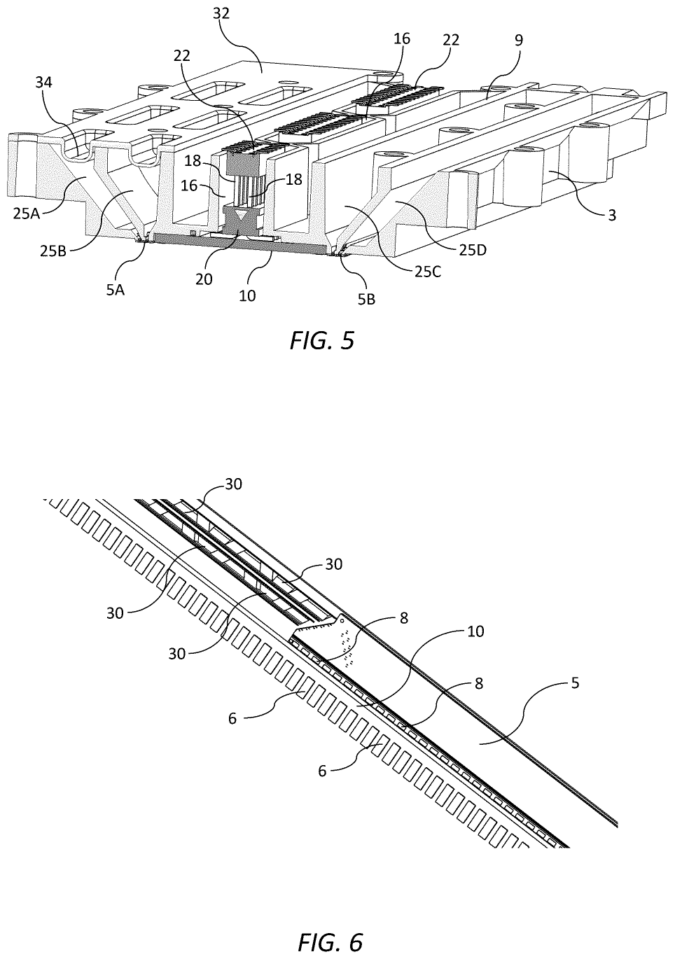

As shown in FIG. 4, the manifold 3 has four ink supply channels 25 extending along a length of the first printhead 1 suitable for supplying four colors of ink (e.g. CMYK) to the first and second rows of print chips 5A and 5B. Ink is supplied to each ink supply channel via respective inlet/outlet ports 27 positioned at opposite ends of the manifold 3. Referring now to FIG. 5, first and second ink supply channels 25A and 25B are positioned at a first side of the through-holes 16 for supplying two colors of ink to the first row of print chips 5A, while third and fourth ink supply channels 25C and 25D are positioned at an opposite second side of the through-holes 16 for supplying another two colors of ink to the second row of print chips 5B. For CMYK printing, and as described in U.S. Pat. No. 10,293,609, each print chip 5 can print redundantly in two colors using four aligned nozzle rows for high-quality printing. Of course, fewer ink colors may be supplied to the two rows of print chips via the four ink supply channels 25 depending on the desired printhead configuration (e.g. monochrome printhead, two-color printhead, etc.).

The ink supply channels 25 generally taper towards rows of ink outlets 30 defined in the lower face of the manifold 3, each respective pair of ink supply channels supplying ink to a paired row of ink outlets, which in turn feed ink into the backsides of print chips contained in either the first row 5A or the second row 5B. As described in U.S. Pat. No. 10,293,609, each print chip has two pairs of backside channels with each pair receiving the same colored ink from respective ink outlets in the manifold. The print chips 5 are designed with a strip of silicon between the two pairs of backside channels for adhesive bonding and fluidic sealing of the two ink pathways. The print chips may be mounted to the manifold 3 via a suitable shim, as described in U.S. Pat. No. 10,293,609, via a die-attach film as described in U.S. Pat. No. 7,347,534 (the contents of each of the foregoing being incorporated herein by reference in their entireties), or via direct adhesive bonding, as shown in FIGS. 5 and 6.

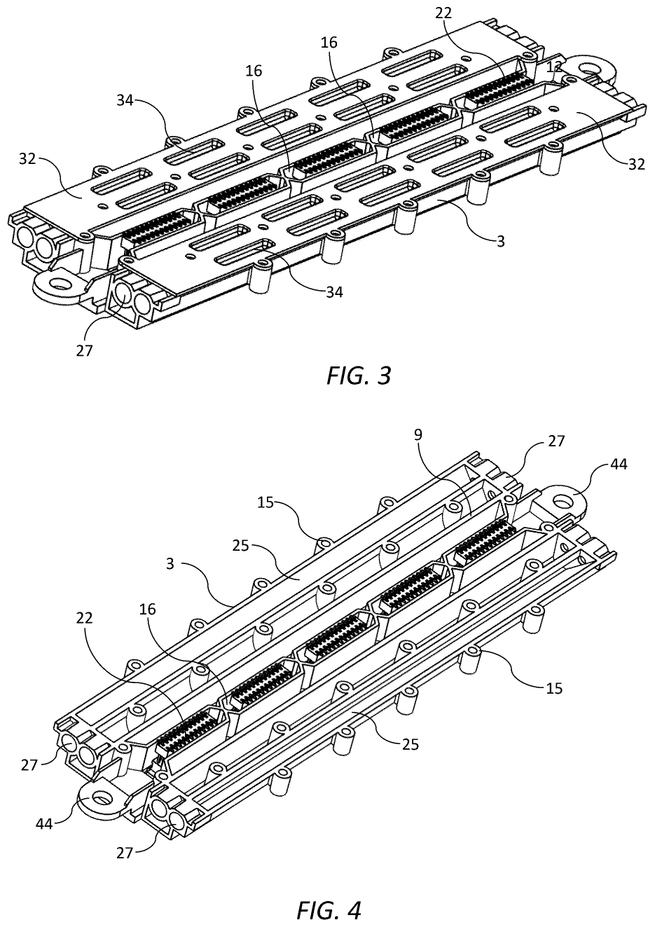

Referring to FIGS. 3 and 5, a pair of membrane gaskets 32 are sealingly bonded to the upper face 9 of the manifold 3 so as to be sandwiched between the manifold and the second PCB 12. As described in U.S. Pat. No. 10,293,609, each membrane gasket 32 is flexible and allows dampening of ink pressure fluctuations along the ink supply channels 25. Bellows or hanging portions 34 are spaced apart along the length of each membrane gasket to optimize dampening of pressure fluctuations.

From the foregoing, it will be appreciated that the first printhead 1 achieves a compact and cost-effective means of printing redundantly in four ink colors from a single printhead. In particular, the distribution of power and data from a common first PCB 10 positioned between the two rows of print chips obviates the requirement for more complex electrical routing dedicated to each row of print chips. Furthermore, the stiffener plate (second PCB 12) allows construction of the manifold 3 from a moldable liquid crystal polymer, whilst maintaining sufficient structural rigidity for a printhead having dual rows of print chips with multiple print chips in each row (e.g. 2 to 11 print chips or 4 to 8 print chips per row). Accordingly, the first printhead 1 is highly suited for stitched arrangements whereby multiple printheads are positioned in a staggered overlapping array with a minimal span of the print zone in the media feed direction.

Referring to FIGS. 8 and 9 there is shown a modular print bar 40 comprising three printheads 1 (or “print modules”) in a staggered overlapping array. With twelve print chips in each printhead (six print chips per row), the print bar is suitable for A3-sized printing. Each first printhead 1 comprises abutment features 42 positioned along its side edges for complementary butting engagement with neighboring printhead(s) in the array. In the first embodiment shown in FIGS. 8 and 9, each second PCB 12 defines the complementary abutment features 42, which assist with alignment of the print modules along the print bar 40. Mounting lugs 44 at opposite ends of each manifold 3 facilitate mounting of the print modules to a suitable print bar chassis (not shown).

### Second Embodiment

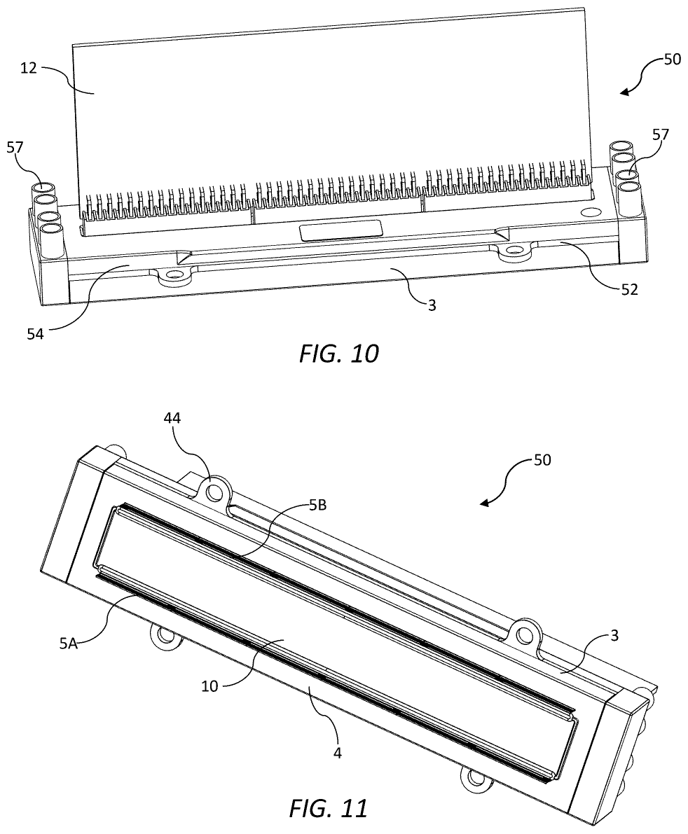

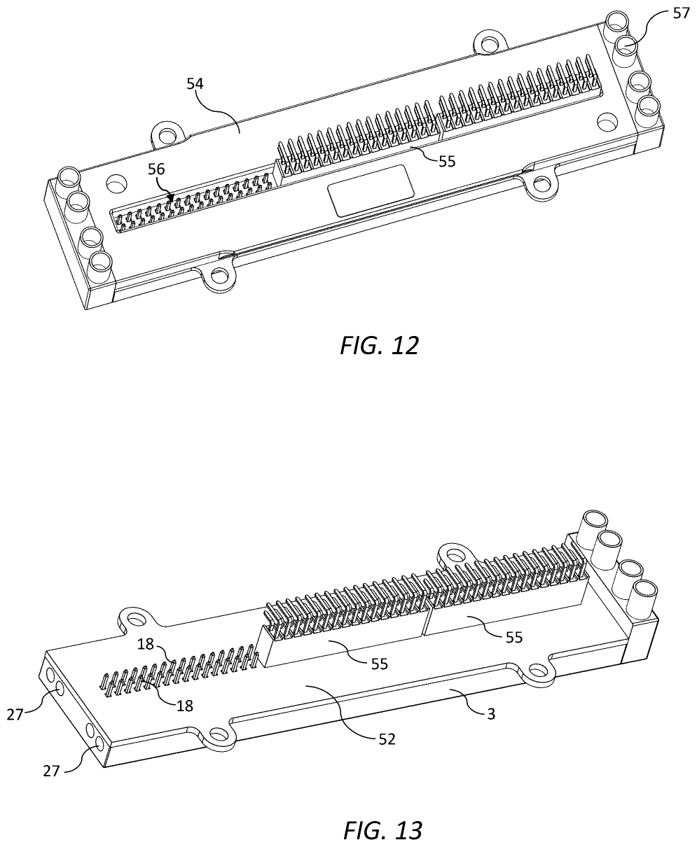

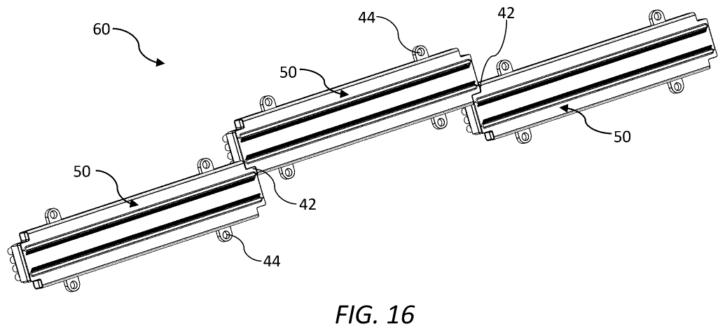

Referring to FIGS. 10 to 15, there is shown a second inkjet printhead 50 (or “print module” when used in a modular array of the type shown in FIG. 16) according to a second embodiment. The second printhead 50 is conceptually similar to the first printhead 1 and, where relevant, like numerals will be used hereinbelow to describe similar or functionally equivalent features.

In common with the first embodiment, the second printhead 50 comprises an elongate manifold 3 configured for supplying ink and power/data to a first row of print chips 5A and a second row of print chips 5B (six print chips in each row) mounted to a lower face 4 thereof. Similarly, the first PCB 10 is co-mounted to the lower face 4 of the manifold 3 between the first and second rows of print chips 5A and 5B. Likewise, the first PCB 10 distributes power and data to both the first and second rows of print chips.

The manifold 3 of the second printhead 50 comprises an LCP molding for high volume/low-cost manufacturing. However, in the contrast with the first embodiment, the stiffener plate 52 attached to an upper face 9 of the manifold 3 takes the form of a metal plate (e.g. Invar plate) with an additional cover plate 54 mounted thereon. In this second embodiment, the second PCB 12 is mounted to the printhead via PCB mounting blocks 55 received in a through-slot 56 of the cover plate 54, with the second PCB 12 extending perpendicularly away from the first PCB 10. Mounting of the second PCB 12 so as to extend away from the manifold 3 advantageously allows heat dissipation from PCB components (not shown) during use.

The second PCB 12 communicates power and data signals to the first PCB 10 via through-holes 16 defined through a thickness of the manifold 3 and corresponding through-holes 56 of the stiffener plate 52. The through-holes 16 (in the form of multiple openings arranged in two rows) are positioned towards a central longitudinal axis of the manifold 3. Each through-hole 16 receives a respective electrical connector 18, which interconnects the first PCB 10 with the second PCB 12.

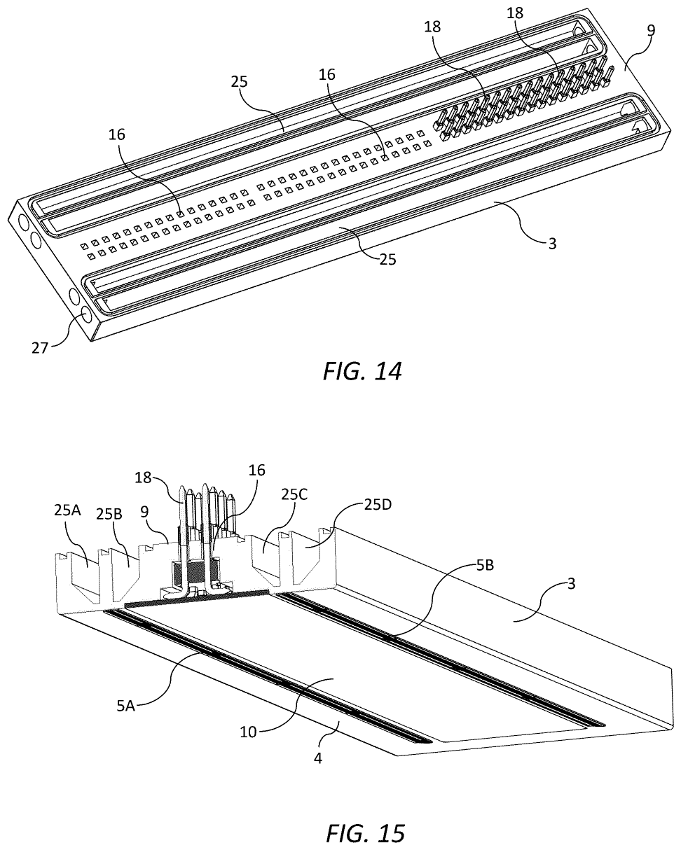

As shown in FIG. 14, and similar to the first embodiment, the manifold 3 of the second embodiment has four ink supply channels 25 extending along a length of the second printhead 50 suitable for supplying four colors of ink (e.g. CMYK) to the first and second rows of print chips 5A and 5B. Ink is supplied to each ink supply channel 25 via respective inlet/outlet ports 27 positioned at opposite ends of the manifold 3. The inlet/outlet ports 27 connect with ink connectors 57, which extend away from second printhead 50 in a direction opposite to a direction of ink ejection.

Referring now to FIG. 15, first and second ink supply channels 25A and 25B are positioned at a first side of the through-holes 16 for supplying two colors of ink to the first row of print chips 5A, while third and fourth ink supply channels 25C and 25D are positioned at an opposite second side of the through-holes 16 for supplying another two colors of ink to the second row of print chips 5B. The ink supply channels 25 generally taper towards rows of ink outlets defined in the lower face of the manifold 3.

Similar to the first embodiment, membrane gaskets 32 (not shown in FIGS. 10 to 15) may be sandwiched between the manifold 3 and the stiffener plate 52 for sealing the ink supply channels 25 and dampening ink pressure fluctuations.

From the foregoing, it will be appreciated that the second printhead 50 according to the second embodiment achieves similar advantages to the printhead 1 according to the first embodiment.

Referring to FIG. 16 there is shown a modular print bar 60 comprising second printheads 50 (or “print modules”) in a staggered overlapping array. Abutment features 42 may be provided on the stiffener plate 52 (and/or manifold 3) to assist with alignment of the print modules, while mounting lugs 44 extending from the stiffener plate 52 facilitate mounting of the print modules to a suitable print bar chassis (not shown).

It will, of course, be appreciated that the present invention has been described by way of example only and modifications of detail may be made within the scope of the invention, which is defined in the accompanying claims.

1. An inkjet printhead comprising:
an elongate manifold having:
an upper face and a lower face:
one or more through-holes defined through a thickness of the manifold, said through-holes being positioned towards a central longitudinal axis of the manifold, and
ink supply channels extending along a length of the manifold, the ink supply channels being positioned towards first and second opposite sides of the manifold relative to the through-holes;
first and second rows of butting print chips mounted to the lower face of the manifold, the first row of butting print chips extending along the first side of the manifold and the second row of butting print chips extending along the opposite second side of the manifold, each print chip in the first row receiving ink from at least one ink supply channel at the first side of the manifold and each print chip in the second row receiving ink from at least one ink supply channel at the second side of the manifold;
a first PCB mounted to the lower face of the manifold between the first and second rows of butting print chips,
wherein:
the first PCB receives power and data via the through-holes from a second PCB; and
the first PCB distributes the power and data to both the first and second rows of butting print chips at either side thereof.

2. The inkjet printhead of claim 1, wherein each through-hole receives one or more electrical connectors interconnecting the first and second PCBs.

3. The inkjet printhead of claim 1, wherein each through-hole is configured as a slot for receiving a plurality of electrical connectors.

4. The inkjet printhead of claim 1, wherein each print chip has a row of bond pads extending along one side thereof, wherein the bond pads of the first and second rows of print chips are each positioned relatively proximal the first PCB, such that the first and second rows of print chips are oppositely oriented relative to each other.

5. The inkjet printhead of claim 1, wherein the manifold is comprised of a molded polymer.

6. The inkjet printhead of claim 1, further comprising a stiffener plate mechanically coupled to the manifold.

7. The inkjet printhead of claim 6, wherein the stiffener plate comprises the second PCB fastened to the upper face of the manifold, the second PCB extending parallel with the first PCB.

8. The inkjet printhead of claim 6, wherein the stiffener plate comprises a metal plate fastened to the upper face of the manifold.

9. The inkjet printhead of claim 1, further comprising a plurality of pressure dampeners communicating with the ink supply channels.

10. The inkjet printhead of claim 9, wherein a membrane gasket comprises the pressure dampeners, the membrane gasket being disposed on the upper face of the manifold to seal the ink supply channels.

11. The inkjet printhead of claim 10, wherein the membrane gasket is sandwiched between the upper face of the manifold and a stiffener plate.

12. The inkjet printhead of claim 1 comprising four ink supply channels suitable for supplying four ink colors to the first and second rows of print chips, wherein first and second ink supply channels positioned at the first side of the manifold supply ink to the first row of print chips and third and fourth ink supply channels positioned at the second side of the manifold supply ink to the second row of print chips.

13. The inkjet printhead of claim 1, wherein each ink supply channel has a corresponding row of ink outlets defined in the lower face of the manifold, the row of ink outlets supplying ink to a respective row of print chips.

14. The inkjet printhead of claim 13, wherein each ink supply channel is tapered towards its respective row of ink outlets.

15. The inkjet printhead of claim 1, further comprising edge features configured for complementary butting engagement of a plurality of said printheads in a staggered overlapping arrangement.

16. The inkjet printhead of claim 15, wherein the edge features are provided on a stiffener plate fastened to the upper face of the manifold.

17. A print bar comprising a modular array of inkjet printheads according to claim 1.
